(19) United States
(12) Patent Application Publication
(10) Pub. No.: US 2017/0174298 A1
(43) Pub. Date: Jun. 22, 2017

(54) NONWOVEN SUBSTRATES WITH NANOCOATING GAS BARRIER

(71) Applicant: Air Cruisers Company, LLC, Wall Township, NJ (US)

(72) Inventor: Deepak Duggal, Avenel, NJ (US)

(73) Assignee: Air Cruisers Company, LLC, Wall Township, NJ (US)

(21) Appl. No.: 15/451,900

(22) Filed: Mar. 7, 2017

Related U.S. Application Data
(63) Continuation-in-part of application No. 15/354,123, filed on Nov. 17, 2016.
Application No. 15/354,123 is a continuation of application No. 15/285,738, filed on Oct. 5, 2016, now Pat. No. 9,527,249.
Application No. 15/285,738 is a continuation-in-part of application No. 15/058,688, filed on Mar. 2, 2016, now Pat. No. 9,481,144.
(60) Provisional application No. 62/304,390, filed on Mar. 7, 2016.
(60) Provisional application No. 62/452,589, filed on Jan. 31, 2017.
(60) Provisional application No. 62/126,898, filed on Mar. 2, 2015.

(51) Int. Cl. B63C 9/04; B64D 25/18; B32B 27/12; B64D 25/14; B32B 5/02; B32B 1/08

(52) U.S. Cl. CPC B63C 9/04; B32B 5/022; B32B 1/08; B32B 27/12; B64D 25/14; B64D 25/18; B32B 2605/18; B32B 2307/7242

(57) ABSTRACT

Embodiments of the present disclosure relate generally to nonwoven substrate materials that find particular use in connection with evacuation slides, evacuation slide/rafts, life rafts, life preservers/vests, or other emergency flotation devices. Such devices are typically formed from woven substrates, but the present inventors have determined that using nonwoven substrates in connection with such devices can provide improved benefits. The nonwoven substrates further have a gas barrier formed thereon by using layer-by-layer (LBL) nanocoating technology.

### CROSS REFERENCE TO RELATED APPLICATIONS

This application claims the benefit of U.S. Provisional Application Ser. No. 62/304,390, filed Mar. 7, 2016, titled “Nanocoated Airholding Fabrics” and U.S. Provisional Application Ser. No. 62/452,589, filed Jan. 31, 2017, titled “Gas Barrier Nonwoven Flexible Composites with Layer by Layer Nanocoating,” the entire contents of each of which are hereby incorporated by reference. This application is also a continuation-in-part application of U.S. Ser. No. 15/354,123, filed Nov. 17, 2016, titled “Nonwoven Flexible Composites,” which application is a continuation of U.S. Ser. No. 15/285,738 filed Oct. 5, 2016 titled “Nonwoven Flexible Composites,” now U.S. Pat. No. 9,527,249, which application is a continuation-in-part of U.S. Ser. No. 15/058,688 filed Mar. 2, 2016 titled “Nonwoven Flexible Composites,” now U.S. Pat. No. 9,481,144, which application claims the benefit of U.S. Provisional Application Ser. No. 62/126,898, filed Mar. 2, 2015, titled “Nonwoven Airholding Fabrics,” the entire contents of which are hereby incorporated by reference.

### FIELD OF THE DISCLOSURE

Embodiments of the present disclosure relate generally to nonwoven substrate materials that find particular use in connection with evacuation slides, evacuation slide/rafts, life rafts, life vests, and other life-saving inflatable devices. Such devices are typically formed from woven substrates, but the present inventors have determined that using nonwoven substrates in connection with such devices can provide improved benefits. The nonwoven substrates have a gas barrier formed thereon by using layer-by-layer (LBL) nanocoating technology.

### BACKGROUND

Federal aviation safety regulations require aircraft to provide evacuation and other safety provisions for passengers. These include evacuation slides, evacuation slide/rafts, life rafts, life vests, and other life-saving inflatable devices. For example, inflatable escape slides and life rafts are generally built from an assembly of inflatable tubular structures that form airbeams that are sealed to one another. Inflatable escape slides and life rafts also have non-airholding features, such as patches, floors, sliding surfaces, girts, handles, and other features. A balance between strength and weight must be reached during the design process.

Traditionally, coated woven fabrics have been used to manufacture inflatable products such as evacuation slides, evacuation slides/rafts, aviation life rafts, marine life rafts, emergency floats, emergency flotation systems, life preservers/vests, emergency flotation devices, inflatable shelters (military and nonmilitary), ship decoys and inflatable military targets, and any other flotation devices, rescue equipment, or other safety device requiring rapid inflation and secure air or gas-holding functions. The inflatable fabric is typically a woven substrate coated or laminated with a thermoplastic polyurethane coating or film. In FIG. 1, the woven substrate 1 is shown having a gas-holding coating 2. In many examples, the base substrate material typically weighs around 4 oz/sq yard and the coating typically weighs around 4 oz/sq yard for a two-sided coated fabric. This totals a weight of about 8 oz/ sq yard. Evacuation slide fabrics have an additional coating on one side that provides reflective properties in order to pass radiant heat test requirements. FIG. 2 illustrates a woven substrate 1 having a gas-holding coating 2 on its inner surface and an abrasion and heat resistant coating 4 on its outer surface.

Evacuation slides provide safe evacuation from an aircraft in the event of an emergency situation, and federal rules require that each aircraft exit door be equipped with an inflatable evacuation slide. This means that substantial weight capacity of the entire aircraft is devoted to the weight of the evacuation slides, and a large portion of the slide weight results from the slide fabric and coating. It is thus desirable to make inflatable evacuation slides as light as possible. The fabric is typically coated with multiple layers of elastomeric polymers to render the material gas impermeable to prevent gas loss during use. The material must also be appropriately flame resistant, have appropriate friction to allow passenger sliding, have sufficient strength to withstand high inflation forces, resist tearing and abrasion, but be light enough so as to not unduly add to aircraft weight.

Such evacuation slides, evacuation slide/rafts, life rafts, life vests, and other life-saving inflatable devices and their accompanying accessories and components are typically formed from woven base substrates. A woven base substrate is coated and/or laminated in order to give it the desired gas holding characteristics. Background about some challenges of using woven fabric to create life-saving inflatables is outlined in U.S. Pat. Nos. 9,481,144 and 9,527,249. These patents provide evacuation slides, evacuation slide/rafts, life rafts, life vests, and other life-saving inflatable devices made of nonwoven materials, the entirety of both of which are hereby incorporated herein by reference.

These material improvements have greatly lowered the weight of evacuation slides, evacuation slide/rafts and other inflatable life-saving devices. The present disclosure can further lower the weight of the resulting materials by providing improved gas barrier coatings.

### BRIEF SUMMARY

Embodiments of the present disclosure provide substrates of nonwoven materials that have a gas barrier layer applied thereto. The gas barrier is intended to reduce the gas transmission rate from the nonwoven material. The gas barrier is applied using layer-by-layer technology on a nanoscale. Use of a nonwoven substrate rather than a woven substrate can reduce the weight of the slide substantially. It has additionally been found that in addition to this weight reduction, it is possible to further reduce fabric weight by applying super thin nanocoating layers using layer-by-layer technology.

In some examples, there is provided a nonwoven substrate material with a gas barrier, comprising: a nonwoven substrate material; a gas barrier applied to at least one surface of the nonwoven substrate material using layer-by-layer technology to apply aligned nanoplatelets onto the nonwoven substrate material. The nonwoven substrate material may form tubular members that form an inflatable device. In specific examples, the inflatable device can be an evacuation slide, an evacuation slide/raft, aviation life rafts, marine life rafts, emergency floats, emergency flotation systems, life preservers/vests, emergency flotation devices, inflatable shelters (military and nonmilitary), ship decoys and inflatable military targets, and any other flotation devices, rescue equipment, or other safety device requiring rapid inflation and secure air or gas-holding functions.

It has been found beneficial to provide the gas barrier coating as a series of cationic and anionic charged materials. An abrasion/heat resistant coating may also be applied on an opposite side of the nonwoven substrate material. It is also possible to provide a coating/film applied beneath or over the layer-by-layer gas barrier.

Examples also relate to a method of manufacturing the nonwoven substrate material with a gas barrier by providing a nonwoven substrate material; applying a first charge to the nonwoven substrate material; applying a first layer of a gas barrier material comprising an opposite charge to the nonwoven substrate material; applying a second layer of a gas barrier material comprising the first charge to the first layer of a gas barrier material; and continuing to apply alternating layers of gas barrier material having an opposite charge to the previous material.

### BRIEF DESCRIPTION OF THE DRAWINGS

FIG. 1 shows a cross-sectional schematic view of a prior art woven substrate with a gas-holding coating on one of the surfaces.

FIG. 2 shows a cross-sectional schematic view of a woven substrate having a gas-holding coating on its inner surface and an abrasion and heat resistant coating on its outer surface.

FIG. 3 shows a cross-sectional schematic view of a nonwoven substrate having a layer-by-layer coating on one of it surfaces.

FIG. 4 shows a cross-sectional schematic view of a nonwoven substrate having a layer-by-layer coating on one of it surfaces and a heat resistant coating applied to the other surface.

FIG. 5 shows a cross-sectional schematic view of a nonwoven substrate having a coating/film applied to one surface and a layer-by-layer coating applied over the coating/film, and a heat resistant coating applied to the other surface.

FIG. 6 shows a cross-sectional schematic view of a nonwoven substrate having a layer-by-layer coating applied to one surface and a coating/film applied over the LBL coating, with a heat resistant coating applied to the other surface and a LBL coating applied over the heat resistant coating.

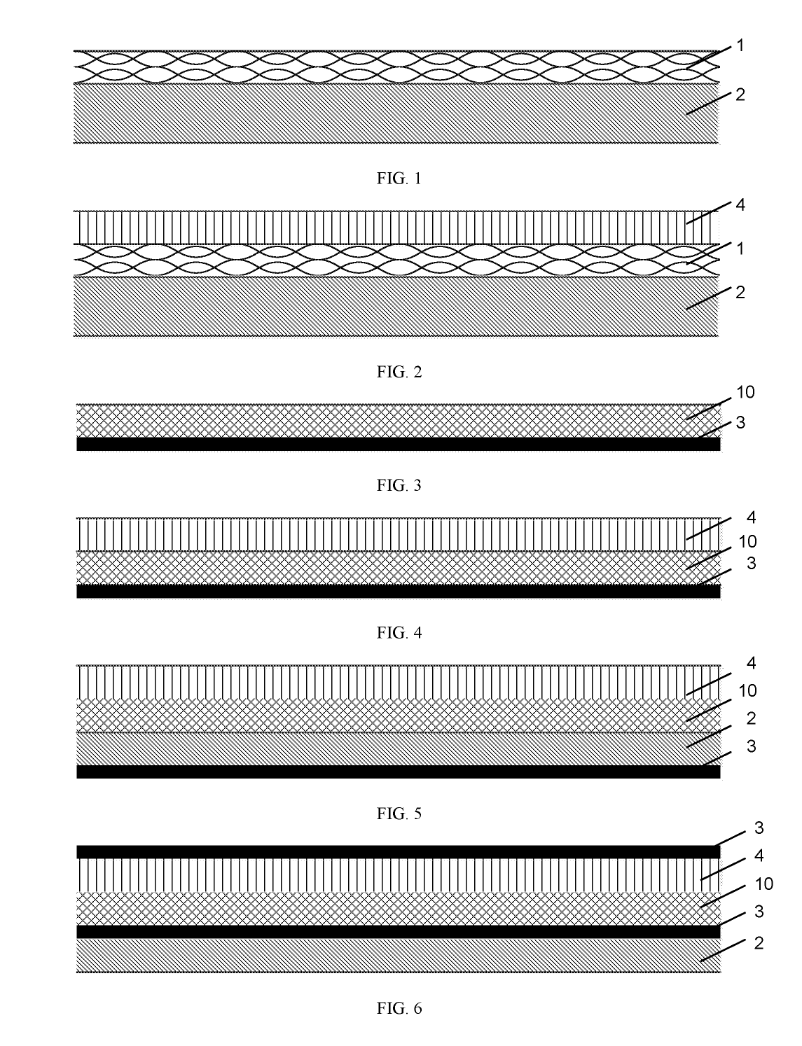

### DETAILED DESCRIPTION

One challenge in designing inflatable devices is to reduce weight of inflatable fabrics for evacuation slides, evacuation slide/rafts, aviation life rafts, marine life rafts, emergency floats, emergency flotation systems, life preservers/vests, emergency flotation devices, inflatable shelters (military and nonmilitary), ship decoys and inflatable military targets, and any other flotation devices, rescue equipment, or other safety devices requiring rapid inflation and secure air or gas-holding functions. One goal has been to reduce the weight to be as low as possible. Although the coated nonwoven materials will be described for particular use with evacuation slides or evacuation slide/rafts, it should be understood that the coated nonwoven materials described herein may be used to manufacture any of these other types of inflatable devices or others, as well. This reduction in fabric weight is accomplished by applying a super thin layer of a gas barrier nano coating or nano platelets using a layer-by-layer (LBL) deposition method. The films described herein may be deposited on one or both sides of the nonwoven substrate. It has been found that this process not only reduces weight of the material, but also provides improved gas barrier properties as compared to traditional coated gas-holding fabrics. The resulting material is a multi-layered construction.

Layer-by-Layer Coating:

The gas barrier LBL coating will now be described. As an initial matter, the term “gas barrier” is used herein to mean a coating or film applied to a substrate material that renders the material generally more gas-holding or air-holding than the material would be without such coating or film. Gas barriers slow or prevent the loss of gas from an inflatable manufactured from the substrate material having the gas barrier applied thereto. The gas barriers described slow air or gas leakage from the material, but have also been found to be lighter than traditional gas barriers used.

Rather than dispersing nanoparticles in a gas barrier coating, the present inventors have found that it is more beneficial to apply layers of nanoparticles. This is referred to as layer-by-layer (LBL) technology. Nanoparticles are layered over a nonwoven substrate material. This causes the nanoparticles to become aligned, much like shingles on a roof, creating a gas barrier over the nonwoven substrate. The individual nanoparticles or nanoplatelets can be considered as self-assembling due to the near-perfect orientation achieved by LBL technology. For example, the nanoplatelets align to be generally parallel with the plane of the nonwoven material substrate surface.

Layer-by-layer coating of nanoparticles can be done by applying a first charge to the nonwoven substrate. This application may be done via dip coating, spraying, or any other appropriate coating or application method. This first charged layer may be referred to as a “first charged layer.” A second layer is then applied over the first charged layer. The second layer contains oppositely-charged groups. A specific layer-by-layer deposition process is followed to ensure continuous formation of layering of the polymers (cations and anions). In other words, the coating is applied to the nonwoven substrate in multiple, consecutively-applied layers of oppositely charged nanoparticles or nanoplatelets in order to provide a gas barrier coating.

In one example, negatively charged particles form a highly structured LBL film when combined with a positively charged substrate. The negatively charged surface of the coating is electrostatically attracted to the positively charged film surface. Further coating layers may be accomplished by providing a negatively charged surface of a coating layer (e.g., a clay nanoparticle or nanoplatelet) attracted to a positively charged surface created by a second coating layer (e.g., a polymer such as PEI or other material described below).

The coating is built up layer by layer, and each layer of the coating is a thin nanometer layer. The deposition particles are charged nanoparticles. In a specific example, the coating may be aqueous cationic and anionic mixtures. In one example, the nonwoven substrate material is exposed to a cationic solution to produce a cationic layer deposited on the substrate. The cationic solution comprises cationic materials. The cationic materials may include a polymer, a clay nanoplatelet, or combinations thereof. Exemplary materials are described further below. The cationic layer is then exposed to an anionic solution to produce an anionic layer deposited on the cationic layer to produce a layer comprising the anionic layer. The anionic solution comprises a layerable material. In addition to layers, thickness of the films may be dependent upon adsorption thickness of each layer deposited, which can be tailored by altering molecular weight, temperature, pH, counterion and ionic strength of the deposition mixture. The concentrations may be varied depending upon the required viscosity of the coating to be applied, how many nanoplatelet layers are to be applied in one coating pass, and any other appropriate manufacturing requirements. The LBL system can show linear growth as a function of layers deposited. The nonwoven substrate may be dried between each dip/rinse in the charged coating.

Various types of coating materials may be used. One specific example includes use of polyethylenimine (PEI) and polyacrylic acid (PAA). Additional examples include but are not limited to phyllosilicate clays, anionic montmorillonite clay, kaolinite clay, boron nitride, mica, sodium montmorillonite (MMT), poly(allylamine hydorochloride) (PAH), nano clays, clay nanoplatelets, or any combinations thereof. It is also possible to provide combinations of mixed clays and polymers to provide coatings.

Exemplary polymers include but are not limited to cationic polymers, branched polyethylenimine, polyethylenimine, cationic polyacrylamide, cationic poly diallyldimethylammonium chloride, poly (melamine-co-formaldehyde), polymelamine, copolymers of polymelamine, polyvinylpyridine, copolymers of polyvinylpyridine, poly(allyl amine), poly(allyl amine) hydrochloride, poly(vinyl amine), poly(acrylamide-co-diallyldimethylammonium chloride), a polymer with hydrogen bonding, polyethylene oxide, polyallylamine, polyglycidol, polypropylene oxide, poly(vinyl methyl ether), polyvinyl alcohol, polyvinylpyrrolidone, branched polyethylenimine, linear polyethylenimine, poly(acrylic acid), poly(methacrylic acid), copolymers thereof, or any combinations thereof.

The negative charged (anionic) layers comprise layerable materials. The layerable materials may include anionic polymers, colloidal particles, phosphated molecules, sulfated molecules, boronic acid, boron containing acids, or any combinations thereof. Non-limiting examples of suitable anionic polymers include branched polystyrene sulfonate (PSS), polymethacrylic acid (PMAA), polyacrylic acid (PAA), polymers with hydrogen bonding, polyethylenimine, poly(acrylic acid, sodium salt), polyanetholesulfonic acid sodium salt, poly(vinylsulfonic acid, sodium salt), or any combinations thereof. In addition, without limitation, colloidal particles include organic and/or inorganic materials. Non-limiting examples of colloidal particles include clays, colloidal silica, inorganic hydroxides, silicon based polymers, polyoligomeric silsesquioxane, carbon nanotubes, graphene, or any combinations thereof. Any type of clay suitable for use in an anionic solution may be used. Non-limited examples of suitable clays include sodium montmorillonite, hectorite, saponite, Wyoming bentonite, halloysite, vermiculite, or any combinations thereof In a specific embodiment, the clay is sodium montmorillonite.

The positive charge (cationic) layers comprise cationic materials. In some embodiments, one or more cationic layers may be neutral. The cationic materials may include polymers, colloidal particles, nanoparticles, nitrogen-rich molecules, or any combinations thereof. In some examples, the polymers may include cationic polymers, polymers with hydrogen bonding, or any combinations thereof. Non-limiting examples of suitable cationic polymers include branched polyethylenimine (BPEI), polyethylenimine, cationic polyacrylamide, cationic poly diallyldimethylammonium chloride (PDDA), poly (melamine-co-formaldehyde), polymelamine, copolymers of polymelamine, polyvinylpyridine, copolymers of polyvinylpyridine, poly(allyl amine), poly(allyl amine) hydrochloride, poly(vinyl amine), poly(acrylamide-co-diallyldimethylammonium chloride), or any combinations thereof. Non-limiting examples of suitable polymers with hydrogen bonding include polyethylene oxide, polyallylamine, polyglycidol, polypropylene oxide, poly(vinyl methyl ether), polyvinyl alcohol, polyvinylpyrrolidone, branched polyethylenimine, linear polyethylenimine, poly(acrylic acid), poly(methacrylic acid), copolymers thereof, or any combinations thereof. Non-limiting examples of colloidal particles include organic and/or inorganic materials, clays, layered double hydroxides (LDH), inorganic hydroxides, silicon based polymers, polyoligomeric silsesquioxane, carbon nanotubes, graphene, or any combinations thereof. Non-limiting examples of suitable layered double hydroxides include hydrotalcite, magnesium LDH, aluminum LDH, or any combinations thereof

Each complementary pair of cationic and anionic layers is known as a bilayer (BL). In one example, the bilayer may be made of PEI/PAA. It is possible for multiple bilayers to be applied, for example 40 bilayers, 80 bilayers, or more. In another example, it is possible to provide a quadlayer (QL). One exemplary quad layer may include a deposition sequence of PEI/PAA/PEI/MMT. Other material combinations are possible and considered within the scope of this disclosure.

Further exemplary materials include those described by U.S. Patent Application Publication Nos. 2016/0114294; 2016/0107192; 2016/0030977; and 2015/0243928, as well as various layer-by-layer articles (“Transparent Clay—Polymer Nano Brick Wall Assemblies with Tailorable Oxygen Barrier (www.acsami.org); “Super Gas Barrier of All-Polymer Multilayer Thin Films” (ACS publications); “Super Gas Barrier of Transparent Polymer Clay—Multilayer Ultrathin Films”) (ACS publications)).

The Nonwoven Substrate:

The base or substrate material to which the described coatings are applied will generally be a nonwoven material. Exemplary nonwoven materials are disclosed by the priority applications recited above, the entire contents of which are incorporated herein by reference. For example, the nonwoven materials are formed as a substrate layer with filaments laid down in various directions. The substrate layer typically has an adhesive or binder combined with the filaments in order to bind the filaments together to form the final substrate.

The filaments of the nonwoven material may be non-continuous or continuous in length. The filaments of the nonwoven material may be unidirectional or multidirectional. They may be in a random orientation filament layout or other random orientation. They may be one or more single strands positioned according to load exhibited on the structure. There may be one or more additional strands positioned on top of the one or more single strands. The substrate of nonwoven material may be a customized fabric comprising filaments laid in particular directions of the expected stress to be experienced by the device to be manufactured. The device may be a tubular structure comprising a hoop direction and a longitudinal direction, wherein there are more filaments in the hoop direction than in the longitudinal direction. If the device has one or more miter seam locations, there can be more filaments at the miter seam location than at other areas of the device.

The nonwoven materials used in this disclosure may include any number of materials. Examples include staple fibers or filaments, which may include cotton or other natural materials. Other examples include filament fibers, which include synthetic materials. One type of nonwoven material that may be used in connection with this disclosure is a nonwoven material that is a laminated mix of carbon and polymer filaments. In one example, the material is a reinforced laminate formed from one or more unidirectional-tapes (also called uni-tapes) laminated to a polymer film. The filament or monofilament material may be carbon and extended chain polyethylene or liquid crystal polymers embedded in a polymer matrix. The material may be an inorganic silicon. The material may be a monofilament aramid. The material may be nylon. The material may be polyester. The material may be cotton. The material may be ultra-high molecular weight polyethylene (UHMWPE) filaments. The material may incorporate boron and/or ceramics. The material may be a material that has typically been used for sailcloth and/or for kites. The material may be combinations of any of the above options. Additional examples are described by U.S. Pat. No. 5,333,568, all of which are considered usable herein. Other materials are possible and considered within the scope of this application. The type of filaments used may be optimized depending upon the particular device to be manufactured. In some examples, the filaments used may have diameters of up to about five times less than conventional strands or threads used for woven materials. Additionally, because of the added strength possible due to configurations of this disclosure, the nonwoven fabric may be about ⅓ of the thickness of a traditional woven fabric used for inflatables.

Because the final materials described herein are designed for use in connection with inflatable structures that must withstand high inflation pressures, the materials used must be designed to withstand such pressures. As background, current evacuation slide, evacuation slide/raft, life raft, and life preserver/vest fabrics must meet FAA requirements listed under appropriate technical standard order (TSO). The TSO prescribes the minimum performance standards (MPS) that these emergency evacuation products must meet. Current woven inflatable gas-holding fabrics have average finished fabric weights of approximately 8.0 oz/sq yard. (A typical breakdown is that 50% (4.0 oz/sq yard) is the substrate weight and 50% (4.0 oz/sq yard) is the coating and/or lamination film weight.) These inflatable fabrics must also meet a minimum tensile strength of 190 lbs/inch (for evacuation slides, evacuation slide/rafts and life rafts) and 210 lbs/inch (for life preservers/vests). These are current requirements set by regulatory authorities, such as the FAA. However, it is believed that the present concepts may also find use on materials that have a tensile strength of 100 lbs/inch, 120 lbs/inch, 130 lbs/inch, 140 lbs/inch, 150 lbs/inch, 160 lbs/inch, 170 lbs/inch, 180 lbs/inch, or any integers therebetween.

Typically, many pieces of fabric (panels) are joined together to form tubular structures. The strength requirement is thus not limited only to the body fabric (the field of the inflatable tube), but is also required on seam areas. In order to keep the gas inside the tubes for long durations, the seams must be sealed together (via thermal welding or adhesive bonding methods) to make them leak proof. Such seams must meet minimum shear strengths of 175 lbs/inch (at room temperature) and 40 lbs/inch (at elevated temperature of 140° F.). Such seams must have a peel strength of 5 lbs/inch (evacuation slides, evacuation slide/rafts and life rafts) and 10 lbs/inch (life preservers/vests). The requirements outlined herein are current requirements; it should be understood that the materials described by this disclosure may have various features modified in order to meet other requirements that may be set in the future or by different regulatory authorities. Safety product inflatables also need to comply with a high pressure test (also called overpressure test) requirement, in which the device must withstand high inflation pressures without causing any damage to the integrity of the seams. For example, evacuation slides are required to withstand two times the maximum operating pressure without failure for at least one minute. Depending upon the tube diameter and maximum operating pressure established for that evacuation slide, the hoop stress/load/force (which is the larger of the two stresses experienced by the seams) can vary. For example; a 24″ diameter tube with 3.5 psi maximum operating pressure would experience hoop stress of about 84 lbs/inch.

Existing nonwoven fabrics available on the market and described by prior art literature are primarily used for low cost commodity items, such as filters, hospital gowns, hygiene products, and so forth. These fabrics are low cost materials, where the necessary and achieved strength is nowhere near the strength required on inflatable products for safety applications, which experience large pressure loads. Existing inflatable nonwoven materials do not meet any of the above-listed TSO strength requirements at desirable weights. This means that in order to reach the desired strength, the materials would need to be so heavy that they would be unworkable for being stored on board a passenger transportation vehicle (such as an aircraft or ship/boat), where reduced weight is a major concern. By contrast, at the desired low weights, currently available nonwoven materials would not have the required strength. Accordingly, the present inventors have specified nonwoven materials having strengths that allow them to be used in the safety inflatable applications described herein, while also having the desired low weights.

The nonwoven substrates used are thus highly engineered nonwoven substrates made with specialized engineered filaments and polymeric layers to achieve the highest strength to weight ratio on inflatable gas-holding fabrics for life-saving inflatable devices. In specific examples, the materials achieve a fabric tensile strength of up to or more than about 190 lbs/inch for evacuation slides, evacuation slide/rafts and life rafts and about 210 lbs/inch for life preservers/vests. In other examples, the materials achieve a fabric tensile strength of up to about 100 lbs/inch. In other examples, the materials achieve a fabric tensile strength of up to about 120 lbs/inch. In other examples, the materials achieve a fabric tensile strength of up to about 130 lbs/inch. In other examples, the materials achieve a fabric tensile strength of up to about 140 lbs/inch. In other examples, the materials achieve a fabric tensile strength of up to about 150 lbs/inch. In other examples, the materials achieve a fabric tensile strength of up to about 160 lbs/inch. In other examples, the materials achieve a fabric tensile strength of up to about 170 lbs/inch. In other examples, the materials achieve a fabric tensile strength of up to about 180 lbs/inch. In specific examples, the materials achieve a shear strength of up to or more than about 175 lbs/inch (at room temperature) and 40 lbs/inch (at 140° F.). In specific examples, the materials achieve a seam peel strength of up to or more than about 5 lbs/inch (slides and life rafts) and 10 lbs/inch (life vests). In specific examples, the materials can withstand TSO overpressure requirements of 2 times the maximum operating pressure.

Manufacture:

It has been found that applying a LBL coating onto a nonwoven substrate (rather than onto a woven fabric) can provide an improved (lowered) gas transmission rate at minimal weight add on. In some instances, two orders of magnitude of improvement may be achieved. For example, test results have shown that the gas transmission rate of the typical woven materials is typically about 192 cc/sq. meter-day When a LBL coating is applied to a woven material, the gas transmission rate can be lowered to about 63 cc/sq. meter-day . However, when a LBL coating is applied to a nonwoven substrate material, the gas transmission rate can be lowered to about 0.8 cc/sq. meter-day. This means that the material is rendered essentially gas impermeable or leak proof for the desired time period, for all practical purposes. The LBL gas barrier layer applied prevents gas loss or otherwise greatly slows the speed of gas loss. This phenomenon may be explained by the fact that woven textile structures have open pores with crimped fibers presenting a non-uniform surface for nanocoatings By contrast, nonwoven substrates are non-porous and flat and offer a uniform substrate for the LBL coating to form a layered brick structure, resulting in improved gas barrier.

The use of a nonwoven material in place of a woven material has been found to reduce the weight of the resulting product, in some instances, up to 50%. The addition of the LBL coatings described herein to the nonwoven material (rather than use of the traditional gas barriers) has also been found to reduce the weight even further. For example, a traditional woven material with a traditional gas barrier coating weighs about 7-8 ounces per square yard. Use of a non-woven material can reduce that weight substantially, in some instances, to about 2-3 ounces per square yard. Use of the LBL coatings described herein can reduce that even further. In some instances, the LBL coating may add up to 1% of the total fabric weight. These weight savings are substantial over the use of traditional woven fabrics with traditional gas barrier coatings.

Referring now to the Figures, FIG. 3 illustrates a LBL coating 3 is applied to a nonwoven base substrate material 10 in order to achieve a gas barrier layer over the nonwoven material. As mentioned above, the nonwoven base substrate material 10 is manufactured from a plurality of filaments bound to one another via an adhesive or binder. The resulting material is represented as nonwoven base substrate material 10. The LBL coating layer 3 provides aligned nanoplatelets. In one example, the nonwoven substrate 10 is roll coated, spray coated, dip coated, or brush coated with the materials. The LBL gas barrier may be followed by processing with an air blade or physical blade to achieve the desired thickness. FIG. 3 illustrates one example of this material construction, showing a nonwoven substrate 10 having a LBL coating 3 applied thereto. The present disclosure provides the benefit of being able to provide a LBL coating 3 directly onto a nonwoven base substrate material 10. Because a nonwoven material 10 generally has a flat surface, the first layer may be the LBL coating 3. (This is generally not the case when a woven fabric is used. Because woven fabrics have open pores , it is generally required that an initial polymer layer be applied to the woven material to provide a working surface. Applicants have unexpectedly found that this step may be eliminated when using a nonwoven base substrate material 10.)

If the nonwoven substrate material 10 is used to form an evacuation slide or evacuation slide/raft, an abrasion and heat resistant coating 4 may be applied to an outer surface, as illustrated by the schematic of FIG. 4. Various types of heat resistant coating layers for inflatable evacuation slides and evacuation slide/rafts are generally known, and any of the available options may be used with this disclosure.

It is also possible to apply a LBL coating 3 over an initial coating layer or film 2, as illustrated by the schematic of FIG. 5. This process would follow the procedures above, but with the first charged layer being applied to the coating layer or film 2, rather than directly to the nonwoven substrate 10. This coating or film 2 is generally a thicker layer than the LBL coating 3. For example, it may be applied to a thickness of ½-1 mil. This coating/film may be one or a combination of the above-described polymers. This coating/film generally does not include the clays described. (This is in contrast to the LBL layer, which may be a combination of polymers and clays). As described above, if the nonwoven substrate material 10 is used to form an evacuation slide or evacuation slide/raft, an abrasion and heat resistant coating 4 may be applied to an outer surface.

In a further embodiment, a coating or film 2 may be applied over the final layer of the LBL coating 3, as illustrated by the schematic of FIG. 6. If the nonwoven substrate material 10 is used to form an evacuation slide or evacuation slide/raft, an abrasion and heat resistant coating 4 may be applied to an outer surface of the nonwoven substrate 10. FIG. 6 also illustrates that another LBL coating 3 may be applied to the abrasion and heat resistant coating 4.

Exemplary combinations of the resulting multi layered nonwoven material may include but are not limited to: providing an LBL coating 3 on the inside or outside of the nonwoven base substrate material 10, or both; sandwiching the nonwoven base substrate material 10 between a coating/film 2 and layering the LBL coating 3 thereover on one or both sides. An optional heat resistant coating 4 may be applied as the final layer. It is also possible to provide a final abrasion resistant layer on one or both surfaces as well.

Layer-by-layer (LBL) nanocoating has also been described for paper fabrication by U.S. Pat. No. 7,842,162. However, this reference does not describe nanocoating on a nonwoven substrate, nor does it disclose nanocoating for use as a gas barrier layer. It is further believed that these technologies have not been used on nonwoven substrates in connection with inflatable life-saving devices.

Layer-by-layer (LBL) polymeric assembly has been used in the food and packaging industry with the goal of keeping outside gasses away from contaminating food. These LBL layers were put on plastic films (such as poly(ethylene terephalate) (PET) films) to prevent gasses such as oxygen, nitrogen and carbon dioxide from entering the plastic films and causing food to spoil more quickly.

By contrast, the present disclosure application applies a LBL polymeric assembly on a nonwoven substrate in order to prevent gas from exiting the inflatable structure. The goal is to keep the inflation gas inside the inflatable device. This has been found to improve gas barrier properties drastically at minimal weight add on. In some instances, the additional weight added to the inflatable can be less than 1%. Other gas barrier coatings have added substantially more weight to the end product, sometimes upwards of 40%.

Instead of polymers that adhere to plastic packaging, the present inventors were challenged with identifying polymers that would adhere to nonwoven inflatable materials and still function with the desired gas barrier properties. It was determined that because the polymers were being applied to inflatable devices, the polymers should be designed or treated so that they do not crack under the strain imparted during inflation.

The coated nonwoven materials disclosed may be formed into an aircraft evacuation slide or evacuation slide/raft. The evacuation slide or evacuation slide/raft is generally formed from tubular members shaped from the coated nonwoven material and a slide surface, along with any other related features or accessories that may be secured to the slide. When inflated, the slide forms a self-supporting structure for evacuation. Although the coated nonwoven materials have been described for particular use with such an evacuation slide or evacuation slide/raft, it should be understood that the coated nonwoven materials described herein may be used to manufacture inflatable devices other than evacuation slides or evacuation slides/rafts. Non-limiting examples include but are not limited to inflatable fabrics for aviation life rafts, marine life rafts, emergency floats, emergency flotation systems, life preservers/vests, emergency flotation devices, inflatable shelters (military and nonmilitary), ship decoys and inflatable military targets, and any other flotation devices, rescue equipment, or other safety device requiring rapid inflation and secure air or gas-holding functions. Other inflatable devices may benefit from use of the technologies disclosed herein as well.

Changes and modifications, additions and deletions may be made to the structures and methods recited above and shown in the drawings without departing from the scope or spirit of the disclosure or the following claims.

What is claimed is:

1. A nonwoven substrate material with a gas barrier, comprising:
a nonwoven substrate material;
a gas barrier applied to at least one surface of the nonwoven substrate material using layer-by-layer technology to apply aligned nanoplatelets onto the nonwoven substrate material.

2. The nonwoven substrate material of claim 1, wherein the nonwoven substrate material forms tubular members that form an inflatable device.

3. The nonwoven substrate material of claim 2, where in the inflatable device comprises an evacuation slide, an evacuation slide/raft, aviation life rafts, marine life rafts, emergency floats, emergency flotation systems, life preservers/vests, emergency flotation devices, inflatable shelters (military and nonmilitary), ship decoys and inflatable military targets, and any other flotation devices, rescue equipment, or other safety device requiring rapid inflation and secure air or gas-holding functions.

4. The nonwoven substrate material of claim 1, wherein the gas barrier coating comprises series of cationic and anionic charged materials.

5. The nonwoven substrate material of claim 4, wherein the materials comprise combinations of polymers and clay materials.

6. The nonwoven substrate material of claim 4, wherein the materials comprise graphene.

7. The nonwoven substrate material of claim 4, wherein the materials comprise polyethylenimine (PEI), polyacrylic acid (PAA), polyacrylamide, polymethacrylic acid (PMAA), branched polyethylenimine (BPEI), montmorillonite (MMT), poly(allylamine hydorochloride) (PAH), nano clays, clay nanoplatelets, graphene, polyethylene oxide, or any combination thereof.

8. The nonwoven substrate material of claim 1, further comprising an abrasion/heat resistant coating on an opposite side of the nonwoven substrate material.

9. The nonwoven substrate material of claim 1, further comprising a coating/film applied beneath or over the layer-by-layer gas barrier.

10. The nonwoven substrate material of claim 1, wherein the nonwoven substrate comprises a series of filaments bonded via an adhesive or binder.

11. A method of manufacturing the nonwoven substrate material with a gas barrier of claim 1, comprising:
providing a nonwoven substrate material;
applying a first charge to the nonwoven substrate material;
applying a first layer of a gas barrier material comprising an opposite charge to the nonwoven substrate material;
applying a second layer of a gas barrier material comprising the first charge to the first layer of a gas barrier material;
continuing to apply alternating layers of gas barrier material having an opposite charge to the previous material.
